(19) United States
(12) Patent Application Publication
(10) Pub. No.: US 2011/0166958 A1
(43) Pub. Date: Jul. 7, 2011

(54) CONDUCTING ROUTE COMMERCE FROM A CENTRAL CLEARINGHOUSE

(75) Inventors: Rick Allen Hamilton, II, Charlottesville, VA (US); James Robert Kozloski, New Fairfield, CT (US); Brian Marshall O'Connell, Cary, NC (US); Clifford Alan Pickover, Yorktown Heights, NY (US)

(73) Assignee: INTERNATIONAL BUSINESS MACHINES CORPORATION, Armonk, NY (US)

(21) Appl. No.: 12/652,127

(22) Filed: Jan. 5, 2010

(51) Int. Cl. G06Q 50/00; G06Q 30/00; G06Q 10/00; G06Q 20/00; G06F 17/30

(52) U.S. Cl. 705/26.25; 705/80; 705/300; 705/348; 705/13; 705/38; 707/766; 707/E17.074; 705/26.3

(57) ABSTRACT

A method and system for managing route resources. After receiving a request for a route from a user, user-specified constraints, route supplier-specified constraints, and weights assigned to the constraints, a dynamic model of available routes is queried to generate proposed routes based on the constraints and weights. The model is updated according to the proposed routes. Current bids on related routes are retrieved. Prices of the proposed routes are determined and presented to the user. The prices are based on the updated model and the current bids on related routes. If no price is acceptable, the user modifies the constraints and a new set of proposed routes is generated. A bid from the user to purchase a selected proposed route is received.

### FIELD OF THE INVENTION

The present invention relates to a data processing method and system for managing route resources, and more particularly to a route management technique that provides and open and dynamic market for routes.

### BACKGROUND OF THE INVENTION

Planning and allocation of route resources including creating and expanding routes (e.g., the building of bridges and widening roads) is performed by a central body (e.g., a government). When creating or expanding routes, the central body considers certain constraints, such as budget, expected future usage, economic benefit, and environmental impact. A traveler may plan a route on a Global Positioning System (GPS) by defining constraints, such as arrival time, no tolls, no highways, etc. The traveler may also plan a route with mapping software (e.g., provided as an Internet-based service), by which the traveler provides a starting point and a destination point and may constrain the route with intermediate destination(s) and way-point(s). Management of route resources relies on users of routes to modify their behavior when the use of a route is too costly. Known techniques for determining the cost of route usage are inefficient and inaccurate because the cost is based on an average cost to all users and fails to account for hidden costs. Thus, there exists a need to overcome at least one of the preceding deficiencies and limitations of the related art.

### SUMMARY OF THE INVENTION

In one or more embodiments, the present invention provides a computer-implemented method of managing route resources. The method comprises:

receiving a request for a route from a user;

receiving a plurality of constraints on the route, wherein the plurality of constraints includes a first set of one or more constraints specified by the user and a second set of one or more constraints specified by a supplier of the route;

receiving a plurality of weights that assign priorities to the plurality of constraints;

querying a dynamic model of a plurality of available routes;

in response to querying the dynamic model, generating one or more proposed routes based on the plurality of constraints and the plurality of weights;

updating the dynamic model according to the one or more proposed routes;

retrieving one or more current bids on one or more other routes related to the one or more proposed routes based on predefined criteria;

a processor of a computer system determining one or more prices of the one or more proposed routes, wherein the one or more prices are based on the updated dynamic model and based on the one or more current bids;

presenting the one or more prices to the user; and

receiving a bid from the user to purchase a selected proposed route of the one or more proposed routes.

A system, program product, and process for supporting computing infrastructure corresponding to the above-summarized method are also described and claimed herein.

Embodiments of the present invention manage route resources by generating routes in an open and dynamic market that sets variable pricing. Further, the present invention may provide a highly effective means of traffic congestion management through advanced road usage charging. Still further, embodiments of the present invention foster environment stewardship by reducing traffic congestion.

### BRIEF DESCRIPTION OF THE DRAWINGS

FIG. 1 is a block diagram of a system for managing route resources, in accordance with embodiments of the present invention.

FIGS. 2A-2B depict a flowchart of a process for managing route resources, where the process may be implemented in the system of FIG. 1, in accordance with embodiments of the present invention.

FIG. 3 is a computer system that is included in the system of FIG. 1 and that implements the process of FIG. 2, in accordance with embodiments of the present invention.

### DETAILED DESCRIPTION OF THE INVENTION

### Overview

One or more embodiments of the present invention provide a method and system that enables a central clearinghouse (e.g., a service) to produce routes for travelers (a.k.a. users or route consumers) that meet resource constraints of the service and route requirements of the travelers. Embodiments of the present invention create an open and dynamic market to set prices for routes requested by travelers, thereby making route-usage costs more transparent. Through route pricing set by the open and dynamic market, suppliers of routes (e.g., governments) may more efficiently allocate routes to consumers of routes (e.g., travelers), thereby effectively managing traffic congestion and fostering environmental stewardship.

The present invention may provide route pricing and re-pricing that is automatic and market-based. In one embodiment, the present invention manages the reselling of existing routes in an after-market and allows route-based financial markets to evolve for the purpose of financing new routes and managing risk among route consumers. The method described herein may also allow for the exchange of routes for other forms of currency, such as money or carbon credits.

### Route Resource Management System

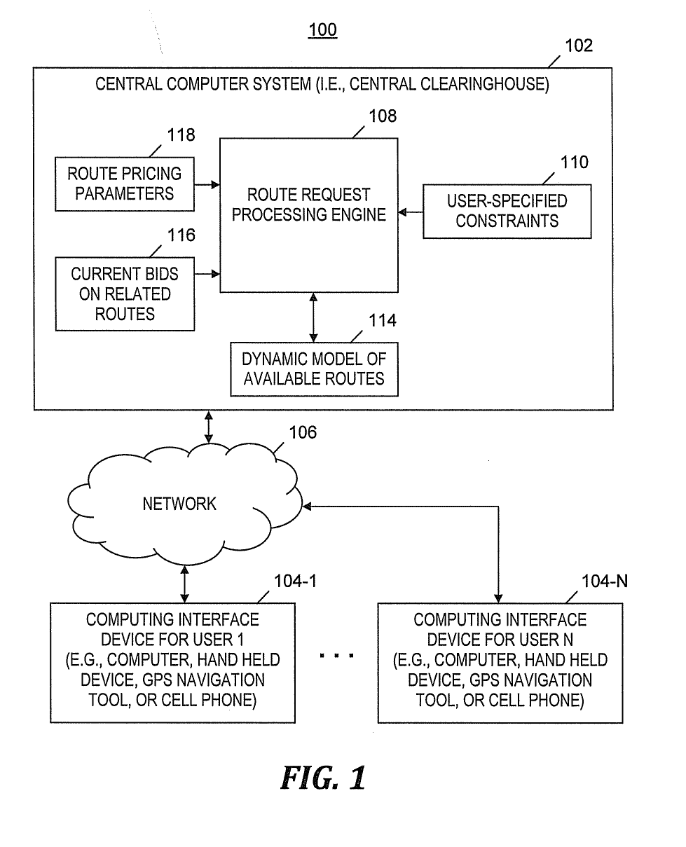

FIG. 1 is a block diagram of a system for managing route resources, in accordance with embodiments of the present invention. System 100 includes a central computer system 102 (a.k.a. central clearinghouse), computing interface devices 104-1, . . . , 104-N, and a network 106. Computing interface devices 104-1, . . . , 104-N are operated by N users, where N≧1. Each computing interface device 104-1, . . . , 104-N may be, for example, a computer, hand held device (e.g., PDA), GPS navigation tool, or a smartphone. Each device 104-1, . . . , 104-N is communicatively coupled to central clearinghouse 102 either via network 106, which may be either a wireless network (e.g., a mobile device network such as Global System for Mobile Communications (GSM)) or a global system of interconnected computer networks (e.g., the Internet). A user interacts with a computing interface device (e.g., device 104-1) in system 100 to enter specifications of one or more routes requested by the user and to enter user-specified constraints on the requested route(s). The user also interacts with the computing interface device to review asking prices of route(s) proposed by the central clearinghouse 102, bid on (i.e., offer to purchase) route(s) proposed by the central clearinghouse 102, and accept routes from the central clearinghouse.

The central clearinghouse 102 may include a set of computing facilities that are communicatively coupled to computing interface devices 104-1, . . . , 104-N, providing multiple users with access to the route management service at any given time. The central clearinghouse 102 includes a software-based route request processing engine 108 that receives and processes requests for routes from users via devices 104-1, . . . , 104-N and network 106. The received requests include specifications of the requested routes and user-specified constraints 110 on the requested routes. The route request processing engine 108 queries a dynamic model 114 of available routes in order to plan new routes according to the users' requests for routes. The central clearinghouse 102 is responsible for maintaining the set of computing facilities and specifying route pricing parameters 118 (a.k.a. clearinghouse-specified constraints) that affect the price of routes, such as route capacities, environmental cost parameters, and tolls and/or charges levied by a government on specific routes or route usage behaviors.

In one embodiment, the central clearinghouse 102 requires high-performance computing options in the set of computing facilities included therein. In one embodiment, the route request processing engine 108 is implemented by a web service using a back-end relational database, such as DB2®, for persistent storage and information retrieval.

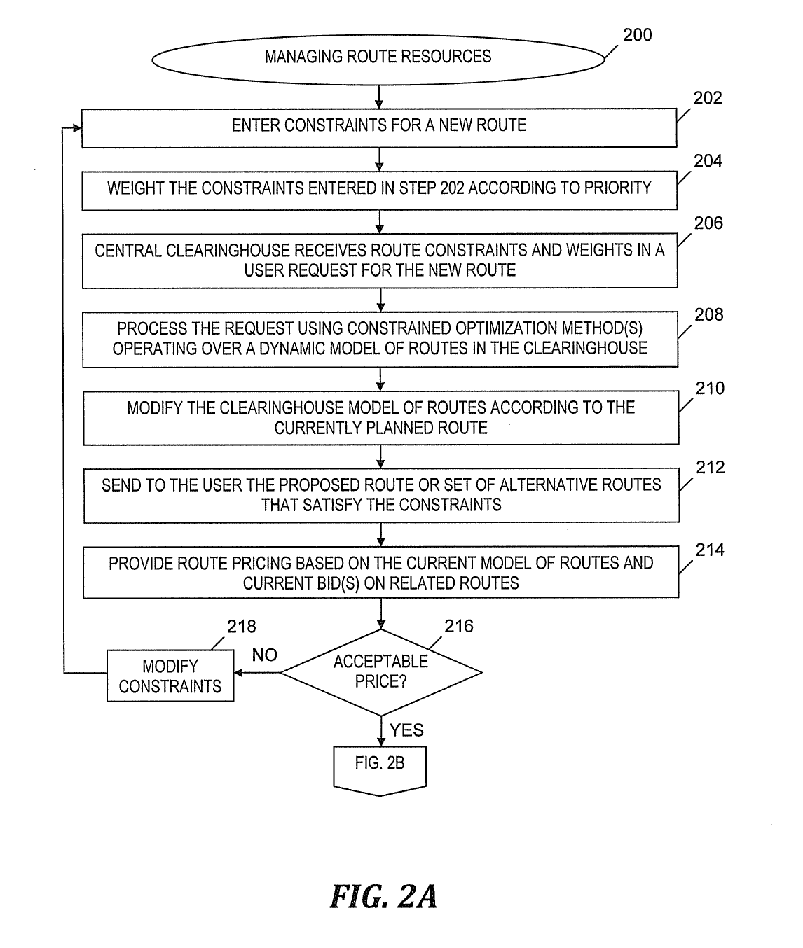

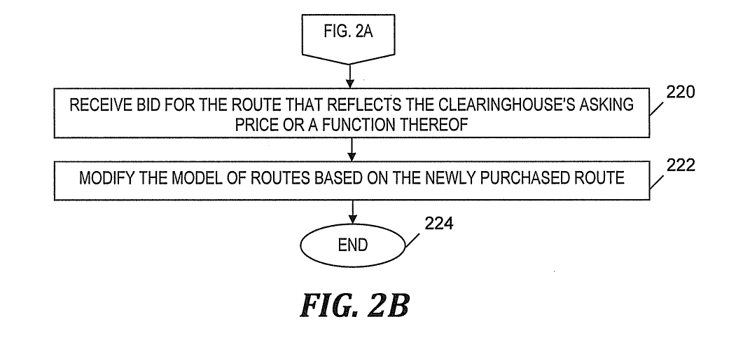

Further descriptions of the functionality of components of system 100 are found in the discussion below relative to FIGS. 2A-2B.

The central clearinghouse 102 provides an open and dynamic electronic market that automatically sets prices for routes requested by the users of computing interface devices 104-1, . . . , 104-N. Rather than using fixed tolls applied uniformly, the market provided by the central clearinghouse 102 automatically sets a price of each of the requested routes based on (1) current demand for the requested route, which is based on current bids 116 on related routes, (2) projected and/or real-time measurements of availability or capacity along the requested route, (3) the time at which the requested route is to be taken, (4) the speed at which the user who requested the route is expected to be traveling, and (5) individual and secondary economic costs associated with taking the requested route. Indications of how the price of a route is affected by the projected and/or real-time measurements of availability or capacity, the time at which a route is to be taken, the speed at which the user is expected to travel the route, and the economic costs associated with taking the route (i.e., the above-listed items (2) through (5)) are included in route-pricing parameters 118. The open and dynamic market that sets route prices is facilitated by ongoing collaboration between the central clearinghouse and the users of the computing interface devices 104-1, . . . , 104-N.

The central clearinghouse 102 has the three primary functions: (1) provide a route planning facility for route consumers that generates routes based on user-specified constraints 110; (2) maintain a dynamic model 114 of all available routes in order to set prices of the routes; and (3) create an open, diverse and dynamic electronic market that sets prices for purchasing routes requested by route consumers, where the prices are based on current bids 116 on related routes and based on route pricing parameters 118. As used herein, related routes are routes that are related according to predefined criteria, where the predefined criteria indicate that parameters of the routes are significantly similar or have a similar effect on the scarcity or supply of routes.

The central clearinghouse 102 improves upon other route generation methods (e.g., GPS-based route planning and mapping software) by enabling routes to be optimized based on both user-specified constraints 110 and clearinghouse-specified constraints 118. Further, these constraints may include acceptable costs (e.g., travel from point A to point B for a price set by the central clearinghouse that is less than $2.00), further distinguishing the method disclosed herein from other route planners. Still further, the route planning facility provided by the central clearinghouse 102 permits iterative modification of the route and/or “route shopping” so that route consumers may be informed of alternatives to any given route.

The central clearinghouse 102 maintains dynamic model 114 of all available routes (e.g., a model of routes stored in a database maintained by the central clearinghouse). Model 114 includes data that indicates not only the location of routes on a map, but also the capacity of each route, current usage statistics for each route, and other fine-scale route details (e.g., the number of lanes available on each route, speed limits, scheduled construction, etc.). The aforementioned current usage statistics may be gathered using road sensors, or through technology such as the Dash Express GPS that transmits congestion information in real time from commuter vehicles. Dash Express GPS is a two-way Internet connected GPS navigation system offered by Dash Navigation, Inc. located in Sunnyvale, Calif. The model 114 evolves in real-time, and thus allows the central clearinghouse 102 to measure the scarcity of the route that has been requested by a user, and to adjust that scarcity measurement dynamically. For example, the model 114 allows a price of a route to be set according to the marginal cost of adding the user who is requesting the route.

The central clearinghouse 102 acts as the arbiter for route auctions and/or route pricing. After a user requests a route (e.g., by providing user constraints 110 via a computing interface device such as device 104-1), a route generated to satisfy the request is compared to the model 114 of all available routes, and to other route(s) currently being priced, where the other route(s) are being requested by other user(s). The central clearinghouse 102 estimates a forward model of route scarcity for each newly generated route. Consumers of newly generated routes compete at auction for the same or similar routes. By implementing the notion of route scarcity, the central clearinghouse 102 establishes the supply of a route and the influence the supply has on the price of the route. Furthermore, the auction measures demand for a route and the influence the demand has on the price of the route.

For example, User 1, who has requested a route from A to B to be driven between 8:00 and 8:30, competes for the requested route with User 2, who has created the same route from A to B to be driven between 8:05 and 8:30 on the same day (i.e., User 2 is expected to drive the requested route faster than User 1). In this case, the model 114 may first provide a measure of overall capacity along the requested route, then anticipate the effect of User 2's faster driving on congestion and the environment, and adjust the coupling between the bids required by User 1 and User 2. If User 1 is required to bid $4.00 for the requested route, User 2 may be required to bid $4.50 to receive the requested route. The additional cost associated with User 2's faster driving makes User 2′s price a function of User 1's price, but not a result of direct competitive bidding between User 2 and User 1.

### Managing Route Resources

FIGS. 2A-2B depict a flowchart of a process for managing route resources, where the process may be implemented in the system of FIG. 1, in accordance with embodiments of the present invention. The route resources management process begins at step 200. In step 202, a user of a computing interface device (e.g., device 104-1 in FIG. 1) in system 100 (see FIG. 1) enters user-specified constraints for a new route that the user is requesting. The user-specified constraints entered in step 202 may include a starting point of the new route, an ending point (i.e., destination) of the new route, a date and time that the user expects to start traveling along the new route, the lane in which the user is expected to travel when traveling along (or along one or more portions of) the new route, the number of passengers expected to be in the vehicle as the vehicle travels along the new route, and/or a price that the user is willing to pay for the route. The user-specified constraints entered in step 202 may be expressed as, for example, maximum or minimum acceptable levels, or averages over time within a variance.

In step 204, the constraints entered in step 202 are assigned weights according to priorities. The weights assigned in step 204 may indicate that one or more of the constraints entered in step 202 are applied in a significantly strict manner, while one or more other constraints are less stringently applied. The weights may be assigned in step 204 by entering the weights via a computing interface device (e.g., by device 104-1 in FIG. 1 operated by the user who is requesting the route) or by automatically assigning the weights by a computing device that applies predefined priorities.

After step 204, a computing interface device sends a request for a route to the central computer system 102 (see FIG. 1) via network 106 (see FIG. 1). The request for the route includes the constraints entered in step 202 and the weights of the constraints assigned in step 204.

In step 206, the route request processing engine 108 (see FIG. 1) receives the request for the route, where the received request includes the user-specified constraints 110, which are the constraints entered in step 202. The received request also includes the weights of the constraints assigned in step 204.

In step 208, route request processing engine 108 (see FIG. 1) processes the request for the route using constrained optimization method(s) operating over dynamic model of the available routes 114 (see FIG. 1). The processing in step 208 generates a currently planned route (a.k.a. proposed route) or a set of alternate proposed routes and generates pricing of the currently planned route or the set of alternate routes. The route(s) generated in step 208 satisfy the user user-specified constraints 110 received in step 206. Hereinafter, the route(s) generated in step 208 are also referred to as the proposed route(s).

In step 210, route request processing engine 108 (see FIG. 1) modifies the dynamic model 114 (see FIG. 1) according to the proposed route(s) generated in step 208.

In step 212, route request processing engine 108 (see FIG. 1) sends the proposed route(s) generated in step 208 via network 106 (see FIG. 1) to a computing interface device (e.g., device 104-1 in FIG. 1) to be presented to a user of the computing interface device.

In step 214, route request processing engine 108 (see FIG. 1) sends the pricing of the proposed route(s) generated in step 208 to the computing interface device that receives the proposed route(s) in step 212. The pricing is sent to the computing interface device in step 214 via network 106 (see FIG. 1) and is viewed by a user who utilizes the computing interface device. The pricing sent in step 214 is based on (1) the current model 114 (see FIG. 1) of the available routes; (2) one or more current bids 116 (see FIG. 1) on related routes; and (3) route pricing parameters 118 (see FIG. 1).

In inquiry step 216, if the user does not find the proposed route(s) and/or pricing of the proposed route(s) to be acceptable based on user-defined criteria, then the No branch of step 216 is taken and the user modifies one or more of the constraints 110 (see FIG. 1) in step 218. After step 218, the process loops back to step 202. Steps 202 through 216 are repeated in a next iteration to process a next request for a next new route, where step 202 in the next iteration includes the user entering the modified constraints for the next new route. Iterations of steps 202 through 216 continue until the proposed route(s) and the pricing generated in step 208 are acceptable to the user according the user-defined criteria.

Returning to step 216, if the user finds that the route(s) and pricing are acceptable based on the user-defined criteria, then the Yes branch of step 216 is taken.

After taking the Yes branch of step 216 and prior to step 220 in FIG. 2B, a user utilizes a computing interface device (e.g., device 104-1 in FIG. 1) to send to the central clearinghouse a bid for (i.e., an offer to purchase) one proposed route (a.k.a. selected route) that the user selects from the proposed route(s). The bid sent by the user prior to step 220 is an offer to pay the price generated for the selected route in step 208 or an offer to pay an amount that is a function of the price generated for the selected route. In step 220 in FIG. 2B, route request processing engine 108 (see FIG. 1) receives and accepts the bid for the selected route. The acceptance of the bid in step 220 indicates that the user is permitted to purchase the selected route. After step 220, the user completes the transaction by purchasing the selected route. By purchasing the selected route, the user is authorized to use the selected route (e.g., travel along the selected route in a vehicle).

In step 222, route request processing engine 108 (see FIG. 1) stores the selected route by modifying the model of available routes 114 (see FIG. 1) based on the newly purchased route indicated by the bid accepted in step 220. Also in step 222, the route request processing engine 108 (see FIG. 1) releases any routes that were previously reserved for the user. Furthermore, the route request processing engine 108 (see FIG. 1) may transmit (not shown in FIG. 2B) a purchase receipt to the user to indicate that the purchase of the selected route is completed. The process of FIGS. 2A-2B ends at step 224.

### Route Generation Using Constrained Optimization

The route generation in step 208 includes the route request processing engine 108 (see FIG. 1) receiving parameters from three sources:

1) The central body (i.e., the supplier of one or more routes; e.g., the government that manages the central clearinghouse 102 in FIG. 1) provides parameters (not shown in FIG. 1) that are slowly varying, and include, for instance, route capacity, target carbon emission for the requested route or a geographical region that includes the requested route, and planned construction along the requested route. The central body may also provide stringency parameters associated with the above-mentioned parameters in a one-to-one correspondence (or associated in a one-to-one correspondence with parameters designated as primary parameters within the above-mentioned parameters). The stringency parameters are utilized in the constrained optimization, as described below.

2) The dynamic model 114 (see FIG. 1) of available routes provides parameters that vary more quickly that the parameters provided by the central body. The parameters provided by dynamic model 114 (see FIG. 1) reflect remotely gathered or market information on all possible routes, such as road conditions, weather conditions, traffic conditions, number of accidents, and the number of purchased routes per unit of road.

The parameters provided by dynamic model 114 (see FIG. 1) may be updated in real time by additional measurements, or when such measurements are not available, by means of a mathematical model that attempts to estimate these parameters (e.g., by means of time interpolation, dynamical systems modeling, etc.).

3) The user provides parameters (i.e., user-specified constraints 110 in FIG. 1) that vary as the user creates and tailors requests for routes using the system interface to set requirements, together with their associated stringency parameters.

After the above-listed parameters are received by the route request processing engine 108 (see FIG. 1), the route request processing engine applies a constrained optimization algorithm in step 208 that uses the above-listed parameters as constraints in the algorithm. The constrained optimization algorithm begins with the constraints and an aggregate fitness requirement for the requested route. The constrained optimization algorithm then performs a search that considers all possible routes and calculates the fitness of each of the considered routes. If none of the considered routes meet the aggregate fitness requirement, the constrained optimization algorithm relaxes the various constraints until a satisfactory route is discovered (i.e., a route that meets the aggregate fitness requirement). Constraints are relaxed as a function of the stringency parameters provided for each parameter (or for each primary parameter), with the most stringent constraint relaxing the slowest. If a satisfactory route is discovered (i.e., a route is found that meets the aggregate fitness requirement), the route is added to a route list, and the constraints are further relaxed until a predefined target number of routes is generated. For example, the processing of a route request in step 208 may yield precisely 10 proposed routes for a user to choose from. Stochastic sampling methods may be employed in searching the space of all possible routes, and in choosing which constraints to relax (e.g., by means of Monte Carlo methods). If no satisfactory routes are discovered and the relaxing of the constraints has resulted in all the constraints reaching their predefined minimum allowable stringencies, a message is relayed to the user that indicates that no route can be found, and that instructs the user to attempt another search. Suggestions for modifying the route parameters can be made based on the initial search results and a determination of which requirements are most difficult to satisfy.

### ADDITIONAL EMBODIMENTS

In a first embodiment, the proposed alternate routes generated in step 208 may include routes that are environmentally friendly according to predefined criteria, such as routes that involve picking up and discharging car pool passengers. These environmentally friendly routes may therefore also be less costly than other routes (i.e., priced less than less environmentally friendly routes). The environmentally friendly routes may elicit benefits from the central body, such as carbon credits/offsets, which are given to the user.

In a second embodiment, the process of modifying a route iteratively after the No branch of step 216 to arrive at an optimal route can be performed alone or collaboratively with other users of the system 100 (see FIG. 1) using on-line collaboration tools that the system supports. The on-line collaboration may be performed, for example, among individuals in a car pool, or for the purpose of chartering a large capacity vehicle such as a bus, airplane, or boat.

In a third embodiment, routes may require a user-provided transportation or may suggest alternative transportation methods (e.g., public transportation, a car pool, etc.). Coupling public transportation fares to the central clearinghouse route commerce facility would make these alternative transportation methods seamless in the basic route purchase transaction. In instances of a first user selecting the alternative of car-pooling with another user, the price of the route may reflect the opportunity cost to the other user for picking up the first user as a passenger in a car-pool, and if this alternative is chosen, the other user may be compensated for car-pooling with the first user.

In a fourth embodiment, the network 106 (see FIG. 1) is a wireless network and the user may modify a selected route via a computing interface device (e.g., device 104-1 in FIG. 1), even while the user is traveling on the selected route. The requirements for allowing modification of the requested route while the user is traveling the route include the central clearinghouse 102 (see FIG. 1) being able to re-price the modified route based on the model 114 (see FIG. 1) and allowing dynamic modifications to the selected route.

In a fifth embodiment, a user enters constraints in step 202 to exploit variation across multiple proposed routes provided by the central clearinghouse 102 (see FIG. 1), where the variation is greatest for the unconstrained or weakly constrained parameters. For example, a user may not constrain the price in order to find out the full range of possible routes and their price structure (e.g., for the purpose of bargain-hunting). In another example, a user may not specify the desired carbon output of the route, to discover the variation in environmental impact that different routes offer.

In a sixth environment, iterative refinement of a route in the loop in FIG. 2A is based on modifications to parameters in queries, or by dynamic modification interfaces (e.g., slider interfaces), such that when the user's computing interface device is communicatively coupled to the central clearinghouse 102 (see FIG. 1) at a high speed, fast updates to routes and their varying parameters may be displayed.

In a seventh embodiment, computation of routes in step 208 may be performed on a remote server in the central clearinghouse 102 (see FIG. 1), or may be performed in part on the user's computing interface device (e.g., device 104-1 in FIG. 1) to reduce communication costs (e.g., by using a Java® applet pushed onto the user's computing interface device by the central clearinghouse).

In an eighth embodiment, routes may be purchased in a block. For example, all commuting for a month may be purchased at one time up front and the price is locked-in to allow a frequent traveler to manage the risk of price volatility among routes.

In a ninth embodiment, routes may be generated and priced through real-world environments, in which environmental impact, capacity, road conditions, etc. are the primary constraints, or in virtual-world environments (e.g., Second Life®) in which the primary cost of taking a route is that of server computational constraints (e.g., the number of residents that the server can effectively render along a particular route). Second Life® is a multi-user, Internet-accessible virtual environment provided by Linden Research, Inc. located in San Francisco, Calif.

In a tenth embodiment, the central clearinghouse has the ability to provide refund(s) to other user(s) who paid for a route prior to a new traveler who is currently purchasing an already congested route at a premium price. Each refund is a predefined portion of the purchase price previously paid by one of the other users. Rather than transferring the marginal cost of adding the new traveler to the other users who already paid for the route (thereby making the marginal cost a hidden cost), the provision of refunds helps prevent the marginal cost of adding the new traveler from being a hidden cost.

### Computer System

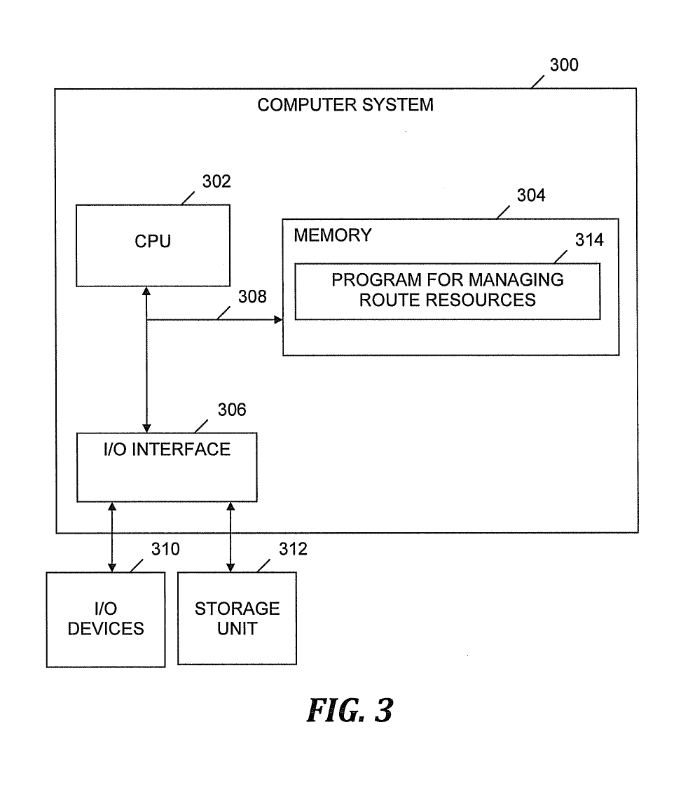

FIG. 3 is a computer system that is included in the system of FIG. 1 and that implements the process of FIGS. 2A-2B, in accordance with embodiments of the present invention. Computer system 300 generally comprises a central processing unit (CPU) 302, a memory 304, an input/output (I/O) interface 306, and a bus 308. Further, computer system 300 is coupled to I/O devices 310 and a computer data storage unit 312. CPU 302 performs computation and control functions of computer system 300. CPU 302 may comprise a single processing unit, or be distributed across one or more processing units in one or more locations (e.g., on a client and server). In one embodiment, central computer system 102 (see FIG. 1) is implemented as computer system 300. In one embodiment, central computer system 102 (see FIG. 1) includes computer system 300.

Memory 304 may comprise any known computer readable storage medium, which is described below. In one embodiment, cache memory elements of memory 304 provide temporary storage of at least some program code (e.g., program code 314) in order to reduce the number of times code must be retrieved from bulk storage while instructions of the program code are carried out. Moreover, similar to CPU 302, memory 304 may reside at a single physical location, comprising one or more types of data storage, or be distributed across a plurality of physical systems in various forms. Further, memory 304 can include data distributed across, for example, a local area network (LAN) or a wide area network (WAN).

I/O interface 306 comprises any system for exchanging information to or from an external source. I/O devices 310 comprise any known type of external device, including a display device (e.g., monitor), keyboard, mouse, printer, speakers, handheld device, facsimile, etc. Bus 308 provides a communication link between each of the components in computer system 300, and may comprise any type of transmission link, including electrical, optical, wireless, etc.

I/O interface 306 also allows computer system 300 to store and retrieve information (e.g., data or program instructions such as program code 314) from an auxiliary storage device such as computer data storage unit 312 or another computer data storage unit (not shown). Computer data storage unit 312 may comprise any known computer readable storage medium, which is described below. For example, computer data storage unit 312 may be a non-volatile data storage device, such as a magnetic disk drive (i.e., hard disk drive) or an optical disc drive (e.g., a CD-ROM drive which receives a CD-ROM disk).

Memory 304 may include computer program code 314 that provides the logic for managing route resources (e.g., the process of FIGS. 2A-2B). Further, memory 304 may include other systems not shown in FIG. 3, such as an operating system (e.g., Linux) that runs on CPU 302 and provides control of various components within and/or connected to computer system 300.

Memory 304, storage unit 312, and/or one or more other computer data storage units (not shown) that are coupled to computer system 300 may store route pricing parameters 118 (see FIG. 1), the dynamic model of available routes 114 (see FIG. 1), and current bids on related routes 116 (see FIG. 1).

As will be appreciated by one skilled in the art, the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “module” or “system” (e.g., system 100 in FIG. 1 or computer system 300). Furthermore, an embodiment of the present invention may take the form of a computer program product embodied in one or more computer readable medium(s) (e.g., memory 304 or computer data storage unit 312) having computer readable program code (e.g., program code 314) embodied or stored thereon.

Any combination of one or more computer readable medium(s) (e.g., memory 304 and computer data storage unit 312) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus, device or any suitable combination of the foregoing. A non-exhaustive list of more specific examples of the computer-readable storage medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with a system, apparatus, or device for carrying out instructions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with a system, apparatus, or device for carrying out instructions.

Program code (e.g., program code 314) embodied on a computer readable medium may be transmitted using any appropriate medium, including but not limited to wireless, wireline, optical fiber cable, RF, etc., or any suitable combination of the foregoing.

Computer program code (e.g., program code 314) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 300 or another computer system (not shown) having components analogous to the components of computer system 300 included in FIG. 3. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIGS. 2A-2B) and/or block diagrams of methods, apparatus (systems) (e.g., FIG. 1 and FIG. 3), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 314). These computer program instructions may be provided to a processor (e.g., CPU 302) of a general purpose computer, special purpose computer, or other programmable data processing apparatus to produce a machine, such that the instructions, which are carried out via the processor of the computer or other programmable data processing apparatus, create means for implementing the functions/acts specified in the flowchart and/or block diagram block or blocks.

These computer program instructions may also be stored in a computer readable medium (e.g., memory 304 or computer data storage unit 312) that can direct a computer (e.g., computer system 300), other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer (e.g., computer system 300), other programmable data processing apparatus, or other devices to cause a series of operational steps to be performed on the computer, other programmable apparatus, or other devices to produce a computer implemented process such that the instructions which are carried out on the computer, other programmable apparatus, or other devices provide processes for implementing the functions/acts specified in the flowchart and/or block diagram block or blocks.

Any of the components of an embodiment of the present invention can be deployed, managed, serviced, etc. by a service provider that offers to deploy or integrate computing infrastructure with respect to the process of managing route resources. Thus, an embodiment of the present invention discloses a process for supporting computer infrastructure, comprising integrating, hosting, maintaining and deploying computer-readable code (e.g., program code 314) into a computer system (e.g., computer system 300), wherein the code in combination with the computer system is capable of performing a process of managing route resources.

In another embodiment, the invention provides a business method that performs the process steps of the invention on a subscription, advertising and/or fee basis. That is, a service provider, such as a Solution Integrator, can offer to create, maintain, support, etc. a process of managing route resources. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flowchart in FIGS. 2A-2B and the block diagrams in FIG. 1 and FIG. 3 illustrate the architecture, functionality, and operation of possible implementations of systems, methods, and computer program products according to various embodiments of the present invention. In this regard, each block in the flowchart or block diagrams may represent a module, segment, or portion of code (e.g., program code 314), which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A computer-implemented method of managing route resources, said method comprising:
receiving a request for a route from a user;
receiving a plurality of constraints on said route, wherein said plurality of constraints includes a first set of one or more constraints specified by said user and a second set of one or more constraints specified by a supplier of said route;
receiving a plurality of weights that assign priorities to said plurality of constraints;
querying a dynamic model of a plurality of available routes;
in response to said querying said dynamic model, generating one or more proposed routes based on said plurality of constraints and said plurality of weights;
updating said dynamic model according to said one or more proposed routes;
retrieving one or more current bids on one or more other routes related to said one or more proposed routes based on predefined criteria;
a processor of a computer system determining one or more prices of said one or more proposed routes, wherein said one or more prices are based on said updated dynamic model and based on said one or more current bids;
presenting said one or more prices to said user; and
receiving a bid from said user to purchase a selected proposed route of said one or more proposed routes.

2. The method of claim 1, further comprising:
in response to said presenting said one or more prices, modifying one or more constraints of said plurality of constraints; and
modifying said one or more proposed routes, wherein said selected proposed route is included in said modified one or more proposed routes.

3. The method of claim 2, wherein said modifying said one or more constraints is performed by multiple users utilizing on-line collaboration tools supported by said computer system.

4. The method of claim 2, wherein said modifying said one or more constraints is performed during a time period in which said user is traveling said selected proposed route.

5. The method of claim 2, wherein said modifying said one or more constraints is performed by modifying one or more parameters in a query or by utilizing a dynamic modification interface.

6. The method of claim 1, further comprising modifying said updated dynamic model in response to said receiving said bid from said user.

7. The method of claim 1, wherein said updating said dynamic model is performed prior to said determining one or more prices of said one or more proposed routes.

8. The method of claim 1, wherein said generating said one or more proposed routes includes:
receiving a plurality of stringency parameters for said plurality of constraints;
receiving a target number of routes to be included in said one or more proposed routes;
receiving an aggregate fitness requirement for designating a proposed route of said one or more proposed routes;
determining a first plurality of fitness values of said plurality of routes;
determining that none of said plurality of fitness values satisfies said aggregate fitness requirement;
in response to said determining that none of said plurality of fitness values satisfies said aggregate fitness requirement, relaxing said plurality of constraints based on said plurality of stringency parameters;
subsequent to said relaxing said plurality of constraints, determining a second plurality of fitness values of said plurality of routes;
determining a fitness value of said second plurality of fitness values satisfies said aggregate fitness requirement, wherein said fitness value indicates a fitness of a route of said plurality of routes to be said proposed route of said one or more proposed routes;
designating said route of said plurality of routes to be said proposed route of said one or more proposed routes based on said fitness value of said second plurality of fitness values satisfying said aggregate fitness requirement;
in response to said determining said fitness of said route, adding said route to a route list;
if said route list includes a number of routes that is less than said target number of routes, repeating the steps of:
said relaxing said plurality of constraints;
determining one or more other fitness values of one or more other routes of said plurality of routes satisfy said aggregate fitness requirement;
designating said one or more other routes to be one or more other proposed routes of said one or more proposed routes; and
adding said one or more other routes to said route list until said number of routes in said route list is said target number of routes.

9. The method of claim 1, wherein said generating said one or more proposed routes includes generating a first route that is designated as environmentally friendly according to predefined criteria and generating a second route that is designated as being not environmentally friendly according to said predefined criteria, and wherein said determining said one or more prices includes determining a first price of said first route and a second price of said second route, wherein said first price is less than said second price based on said first route being environmentally friendly and said second route not being environmentally friendly.

10. The method of claim 1, further comprising sending to said user one or more identifications of one or more alternative transportation methods for traveling said selected proposed route.

11. The method of claim 10, wherein said sending said one or more identifications includes sending an identification of a transportation method that includes public transportation, and wherein said determining said one or more prices is based on a fare charged by said public transportation.

12. The method of claim 10, wherein said sending said one or ore identifications includes sending an identification of a transportation method that includes car-pooling with a second user, and wherein said method further comprises compensating said second user for car-pooling with said user.

13. The method of claim 1, further comprising:
receiving a selection by said user of a parameter to not be included in said plurality of constraints; and
presenting to said user a variation in said parameter across multiple proposed routes.

14. The method of claim 1, wherein said generating said one or more proposed routes is performed by a remote server included in said computer system that determines said one or more prices or in part by a computing interface device operated by said user.

15. The method of claim 1, further comprising:
receiving an amount of time during which said user desires to travel said route multiple times; and
generating a price for traveling said route said multiple times in said amount of time.

16. The method of claim 1, wherein said one or more proposed routes are in a real-world environment or a virtual-world environment.

17. The method of claim 1, further comprising:
receiving one or more payments for said selected proposed route prior to said receiving said request from said user, wherein said one or more payments are received from one or more users other than said user; and
subsequent to said receiving said bid from said user, refunding one or more portions of said one or more payments to said one or more users.

18. A computer system comprising a processor, a computer readable memory, a computer readable storage medium, and program instructions stored on said computer readable storage medium, said program instructions configured to be carried out by said processor via said computer readable memory to implement the method of claim 1.

19. A computer program product, comprising a computer-readable storage medium having a computer-readable program code stored therein, said computer-readable program code containing instructions configured to be carried out by a processor of a computer system to implement the method of claim 1.

20. A process for supporting computing infrastructure, said process comprising providing at least one support service for at least one of creating, integrating, hosting, maintaining, and deploying computer-readable code in a computer system, wherein the code in combination with the computer system is capable of performing a method of managing route resources, said method comprising:
receiving a request for a route from a user;
receiving a plurality of constraints on said route, wherein said plurality of constraints includes a first set of one or more constraints specified by said user and a second set of one or more constraints specified by a supplier of said route;
receiving a plurality of weights that assign priorities to said plurality of constraints;
querying a dynamic model of a plurality of available routes;
in response to said querying said dynamic model, generating one or more proposed routes based on said plurality of constraints and said plurality of weights;
updating said dynamic model according to said one or more proposed routes;
retrieving one or more current bids on one or more other routes related to said one or more proposed routes based on predefined criteria;
a processor of said computer system determining one or more prices of said one or more proposed routes, wherein said one or more prices are based on said updated dynamic model and based on said one or more current bids;
presenting said one or more prices to said user; and
receiving a bid from said user to purchase a selected proposed route of said one or more proposed routes.

21. The process of claim 20, wherein said method further comprises:
in response to said presenting said one or more prices, modifying one or more constraints of said plurality of constraints; and
modifying said one or more proposed routes, wherein said selected proposed route is included in said modified one or more proposed routes.

22. The process of claim 21, wherein said modifying said one or more constraints is performed by multiple users utilizing on-line collaboration tools supported by said computer system.

23. The process of claim 21, wherein said modifying said one or more constraints is performed during a time period in which said user is traveling said selected proposed route.

24. The process of claim 21, wherein said modifying said one or more constraints is performed by modifying one or more parameters in a query or by utilizing a dynamic modification interface.

25. The process of claim 20, wherein said method further comprises modifying said updated dynamic model in response to said receiving said bid from said user.

26. The process of claim 20, wherein said updating said dynamic model is performed prior to said determining one or more prices of said one or more proposed routes.

27. The process of claim 20, wherein said generating said one or more proposed routes includes:
receiving a plurality of stringency parameters for said plurality of constraints;
receiving a target number of routes to be included in said one or more proposed routes;
receiving an aggregate fitness requirement for designating a proposed route of said one or more proposed routes;
determining a first plurality of fitness values of said plurality of routes;
determining that none of said plurality of fitness values satisfies said aggregate fitness requirement;
in response to said determining that none of said plurality of fitness values satisfies said aggregate fitness requirement, relaxing said plurality of constraints based on said plurality of stringency parameters;
subsequent to said relaxing said plurality of constraints, determining a second plurality of fitness values of said plurality of routes;
determining a fitness value of said second plurality of fitness values satisfies said aggregate fitness requirement, wherein said fitness value indicates a fitness of a route of said plurality of routes to be said proposed route of said one or more proposed routes;
designating said route of said plurality of routes to be said proposed route of said one or more proposed routes based on said fitness value of said second plurality of fitness values satisfying said aggregate fitness requirement;
in response to said determining said fitness of said route, adding said route to a route list;
if said route list includes a number of routes that is less than said target number of routes, repeating the steps of:
said relaxing said plurality of constraints;
determining one or more other fitness values of one or more other routes of said plurality of routes satisfy said aggregate fitness requirement;
designating said one or more other routes to be one or more other proposed routes of said one or more proposed routes; and
adding said one or more other routes to said route list until said number of routes in said route list is said target number of routes.

28. The process of claim 20, wherein said generating said one or more proposed routes includes generating a first route that is designated as environmentally friendly according to predefined criteria and generating a second route that is designated as being not environmentally friendly according to said predefined criteria, and wherein said determining said one or more prices includes determining a first price of said first route and a second price of said second route, wherein said first price is less than said second price based on said first route being environmentally friendly and said second route not being environmentally friendly.

29. The process of claim 29, wherein said method further comprises sending to said user one or more identifications of one or more alternative transportation methods for traveling said selected proposed route.
